(19) United States
(12) Patent Application Publication
(10) Pub. No.: US 2013/0226330 A1
(43) Pub. Date: Aug. 29, 2013

(54) OPTICAL TECHNIQUES FOR MONITORING CONTINUOUS MANUFACTURING OF PROTON EXCHANGE MEMBRANE FUEL CELL COMPONENTS

(71) Applicants: Bhushan Sopori, Denver, CO (US); Michael Ulsh, Broomfield, CO (US); Przemyslaw Rupnowski, Bay City, MI (US)

(72) Inventors: Bhushan Sopori, Denver, CO (US); Michael Ulsh, Broomfield, CO (US); Przemyslaw Rupnowski, Bay City, MI (US)

(73) Assignee: Alliance For Sustainable Energy, LLC, Golden, CO (US)

(21) Appl. No.: 13/405,129

(22) Filed: Feb. 24, 2012

(51) Int. Cl. G05B 15/00; G01J 3/00; G01N 21/55; G01B 11/28; G01J 1/00; G01N 21/00

(52) U.S. Cl. 700/117; 356/213; 356/432; 356/445; 356/630; 356/51

(57) ABSTRACT

A system for analyzing one or more proton exchange membranes is disclosed. The system may include a light source, a light detector, a light source driver and a central processing unit or computer. The system may determine one or more characteristics of the one or more proton exchange membranes. The system may include a roller or belt system in communication with the central processing unit, light source, light detector and light source driver, configured for use in a manufacturing assembly line.

### CONTRACTUAL ORIGIN

The United States Government has rights in this invention under Contract No. DE-AC36-08GO28308 between the United States Department of Energy and the Alliance for Sustainable Energy, LLC, the manager and operator of the National Renewable Energy Laboratory.

### BACKGROUND

Fuel cells incorporating proton exchange membranes (PEM) have gained considerable acceptance for automotive, stationary and portable, power needs. FIG. 1 illustrates a block diagram of a PEM fuel cell 100. The fuel cell 100 utilizes a polymer electrolyte membrane 102 placed between an anode catalyst 104 and anode gas diffusion layer (GDL) 105 and a cathode catalyst 106 and cathode gas diffusion layer 107. A fuel source 108 provides hydrogen to the anode catalyst 104, where hydrogen ions 113 and electrons 111 are formed. The electrons 111 generate electricity in an external electric circuit 110. At the cathode catalyst 106, oxygen 112 from the air combines with the hydrogen ions 113 that pass through the membrane 102 and the electrons 111 from the external circuit 110 to form water 114. Heat is also typically generated by the fuel cell 100. A variety of different membranes are used in PEM fuel cells, depending on the fuel and expected operating conditions. Polyfluorinated sulfonic acid (PFSA) membranes are the most well known and most widely used PEM membrane, as exemplified by DuPont Nafion®. Non-fluorinated, so-called ‘hydrocarbon’ membranes are also used, as well as membranes that carry phosphoric acid as an electrolyte, such as polybenzimidizole (PBI). Single as well as multi-layer membranes are used. Electrodes (anode and cathode), most typically consisting of platinum on a carbon support mixed with the same (or similar) ionomer used in the membrane, are coated onto either the membrane (forming a catalyst-coated membrane or CCM) or the GDL (forming a gas diffusion electrode or GDE). The GDLs are a porous mat of randomly aligned carbon fibers, typically with an impregnation of a polymer, such as polytetrafluoroethylene (PTFE) to control water wetting. The GDLs also often have a dense carbon coating on one side, referred to as the micro-porous layer, which provides a uniform mating surface and mass transfer properties for the electrode.

The fuel cell market is expected to grow rapidly in the near future. As this growth occurs, the fuel cell industry will require monitoring techniques that are fast, non-destructive, and capable of high throughput with production in-line operation. Such monitoring will be beneficial for membranes, electrode coatings, and gas diffusion layers, amongst others. The properties that may be monitored include, but are not limited to, catalyst distribution and loading, electrode structure and porosity, membrane thickness and composition uniformity, extent of curing, gas diffusion layer porosity, surface structure, and hydrophobicity.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of this disclosure involve several optical, typically non-contact, techniques, for measurement of a number of parameters that can be used for monitoring production of fuel cell membranes, GDLs, and electrodes. Generally speaking, measurement of total reflectance and/or transmittance of a membrane at selected wavelengths or a range of wavelengths alone or in combination with interference fringe measurements yields, information suitable for deriving several useful parameters. It should be pointed out that the total reflectance of a membrane includes contributions from each surface as well as that due to the absorbance within the thickness of the membrane. The parameters that can be measured by these techniques include but are not limited to: (i) thickness and composition of large-area PEM membranes, (ii) characteristics of GDL materials, and (iii) porosity and surface morphology of electrodes. The apparatus and methods discussed herein may monitor such parameters at production line speeds and are hence suitable for monitoring very large throughput. These techniques may be used individually or in combination in commercial production.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates a block diagram of a fuel cell.

FIG. 2 illustrates a transmission spectrum of a 2-mil Nation® membrane showing various absorbance regions and interference effects, with arrows indicating narrow, local absorption peaks.

FIG. 3 shows a diagram of the reflectance spectra of the following gas diffusion layers of different configurations: a densely woven medium with an electrode; a densely woven medium without an electrode; a loosely woven medium without an electrode; and a loosely woven medium with an Al back-reflector.

FIG. 4 shows a diagram illustrating the transmission spectra of two gas diffusion layers: a loosely-woven carbon medium having transmission between 35% and 37% and a densely woven carbon medium having transmission less than 1%.

FIG. 5 is a diagram illustrating the reflectance spectra of a Nation® membrane with (upper curve) and without (lower curve) electrode material.

FIG. 6 is a diagram illustrating the reflectance spectrum of another electrode material on a Nation® membrane.

FIG. 7 is a diagram of the transmission spectrum of a Nafion® membrane with an electrode material illustrating optical “porosity” of the electrode.

FIG. 8 is a diagram of the specular transmission spectra of two Nafion® membranes of the following thicknesses: (a) 2 mils and (b) 4 mils.

FIG. 9 is a diagram of the enlarged fringe pattern for □ in the range of 1400 nm and 1500 of FIG. 8.

FIG. 10 is a diagram of the transmission and reflectance spectra of a 1 mil thick Nafion® membrane, illustrating presence of fringes both in the transmission and the reflectance spectra.

FIG. 11 is a diagram of the transmission spectra of three Nafion® membranes of the nominal thicknesses of 1 mil, 2 mils, and 4 mils.

FIG. 12 is a diagram illustrating the calculated absorption coefficients of three Nafion® membranes described in FIG. 11, showing that their compositions are different.

FIG. 13 is a diagram illustrating use of reflectance spectrum to measure effective absorption and the thickness of thin membranes. Reflectance spectra in the visible region for two Nafion® films, A and B, both separately and in combination on an Al background.

FIG. 14 is a diagram illustrating measurement of the porosity of an electrode in relation to the transmission of the electrode.

FIG. 15 is a diagram of the reflectance and transmittance of a gas diffusion layer-1.

FIG. 16 is a diagram of the reflectance and transmission of a GDL (loosely woven material). Also shown is the reflectance with Al reflector behind the GDL.

FIGS. 17A-B illustrate a schematic diagrams of: (A) system for making thickness and porosity measurements using transmission; and (B) system for controlling the ambient for optical measurement by reflecting or absorbing enclosures;

FIG. 18 is a diagram of the transmission and reflectance spectra of two membranes (NRE-211 and NRE-212) of very low absorbance in the Vis-UV range. Membrane thickness: NRE-211=1 mil, NRE-212=2 mil;

FIG. 19 is a diagram of a system for reflectance measurement over the width of a membrane;

FIG. 20 is a schematic diagram of a system for reflectance and fringe measurement using multiple LED and detector combinations;

FIG. 21 is a schematic diagram of a system for reflectance and absorbance measurement and imaging (using principle of reflectometer); and

FIG. 22 illustrates spectrographic measurement data for a membrane folded over on itself to simulate three different membrane thicknesses.

FIG. 23 illustrates an image of two different defects inside PEM membranes: (a) sample with a line of bubbles, (b) sample with an invisible impression defect resulting in a 10% thickness reduction

FIG. 24 illustrates an example of an automated system for continuously measuring materials using transmission principles.

FIG. 25 illustrates the automated system of FIG. 24, according to other embodiments.

FIG. 26 illustrates a side view of an automated system for continuously measuring a material.

FIG. 27 illustrates an automated system for continuously measuring a material using reflectance principles.

FIG. 28 illustrates the automated system of FIG. 27, according to other embodiments of the present invention.

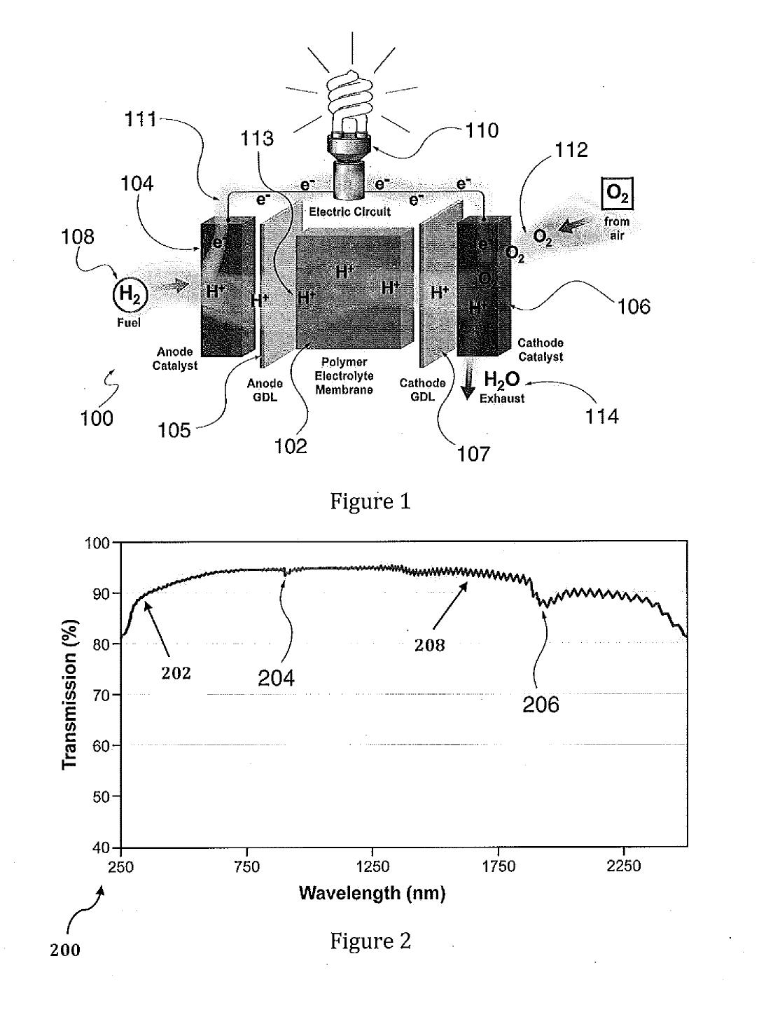

### DETAILED DESCRIPTION

Aspects of the present disclosure involve systems, apparatus, and methods for measuring characteristics of PEM fuel cell components through measurement of reflectance and/or transmittance characteristics of the material alone or in conjunction with interference fringe pattern Through the measurement of reflectance and transmittance, at selected light wavelengths or ranges of wavelengths, systems and methods described herein may be utilized to derive membrane thickness, composition, porosity, surface morphology of membrane electrode assembly (MEA) components, and other characteristics, in a production environment.

The following describes detailed spectroscopic measurements on different PEM membranes, electrode materials, and GDLs, which provide the basis for the systems and methods described. We will describe several transmission and reflectance measurements that can be used individually or combined to characterize one or more fuel cell parameters.

FIG. 2 shows transmission spectrum 200 of a Nafion® film with a nominal thickness of 2 mils. FIG. 2 illustrates several features, which include, among other things, a broad absorption band 202 in the UV-Visible range of wavelengths, absorption in this region depends on the film thickness as well as the chemical composition; narrow, local absorption bands distributed within the entire spectrum at wavelengths identified by arrows 204 and 206 in FIG. 2; and low absorption regions, particularly in the wavelength range of 1300 nm and 1750 nm, exhibiting well-defined interference fringes 208.

From the spectroscopic data it can be seen that absorption characteristics of PEM membranes have wavelength regions of high absorption and low absorption. It should be noted that DuPont Nafion® membranes are shown and described herein only for illustrative purposes and the principles and embodiments described and illustrated are applicable to other PEM membranes, such as those provided by 3M, Arkema, W.L. Gore and Associates, BASF, Asahi Glass, Solvay Solexis, and others.

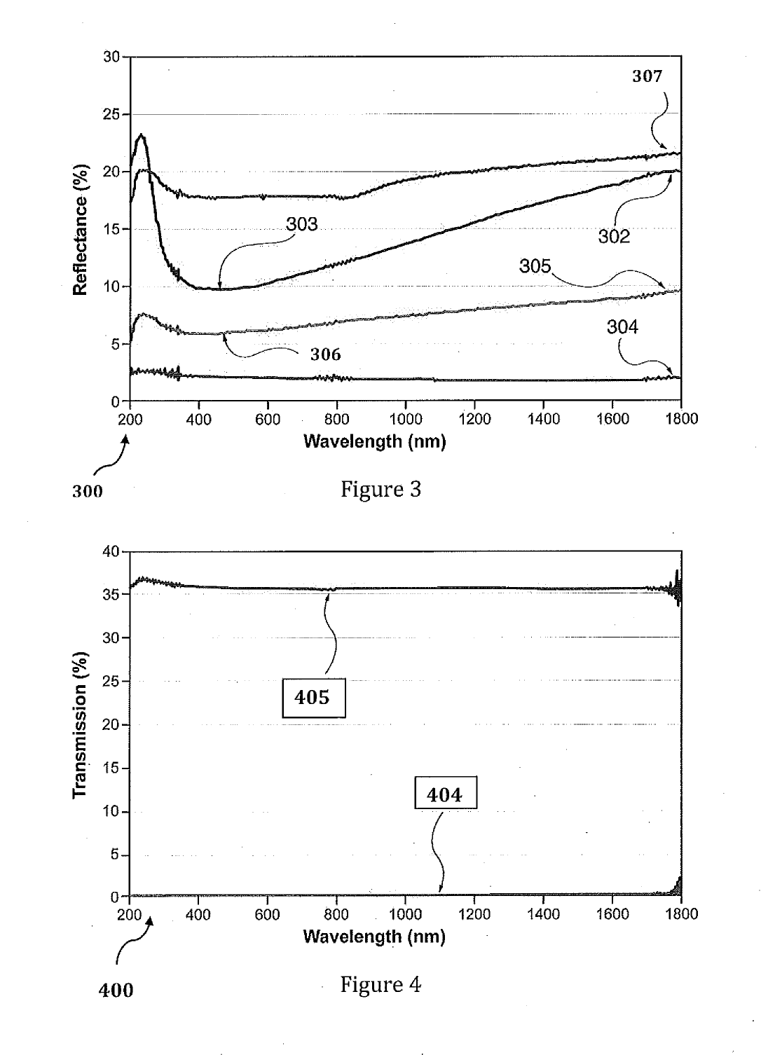

FIG. 3 shows reflectance spectra 300 of several gas diffusion electrode materials and support papers. The support papers may involve a loosely or densely woven carbon fiber material. Several features can be observed including, but not limited to: curve 302 shows the reflectance spectrum of the densely woven GDL carbon paper only (without a deposited electrode material). The reflectance of this support material ranges between 10% and 23% and has a dip 303 at about 400 nm. Due to the dense nature of the fibers, this paper has a very low transmittance and, hence low porosity. Furthermore, curve 304 shows the reflectance spectrum of a densely woven GDL carbon paper with an electrode deposited on it. It can be seen that the reflectance of the electrode is about 2% within the entire spectrum. This paper also has very low transmittance, due to the dense nature of the fiber, (see FIG. 4).

Curve 305 shows the reflectance spectrum of a non-woven GDL, having a relatively less dense structure than woven paper of curve 304 (See also FIG. 4 showing about 35% transmission). Hence, the paper of curve 305 has a lower reflectance than the paper of curve 304, but shows a dip 306 at about 400 nm similar to the dip 303, albeit less pronounced.

The reflectance of GDL paper shown by curve 305 is lower than that of the densely structured GDL paper of curve 302, because of its semitransparent nature of being less dense. By placing the less dense paper on an aluminum reflector, the reflectance spectrum shifts to curve 307. The shape of the curve 307 is slightly modified, because Al is not a perfect reflector. The Al reflector was used to demonstrate that measurement of reflectance can be applied to observe the transparency (or the porosity) of the support-paper. To wit, measurement of reflectance is indicative of porosity of the support paper.

It is clear that PEM electrodes exhibit a reflectance spectrum, which is characteristic of the electrode surface morphology. Furthermore, the support papers or membranes have surface morphologies that generate characteristic features in the reflectance spectrum.

FIG. 4 identifies the transmission spectra of two GDLs: a loosely woven GDL (405) with transmission between 35% and 37%, and a densely woven GDL (404) having transmission of about 0.2%. The corresponding reflectance spectra of these GDLs, shown in FIG. 3, as 305 and 304, respectively. Thus, it will be noted that loosely woven GDL has lower reflectance and higher transmission.

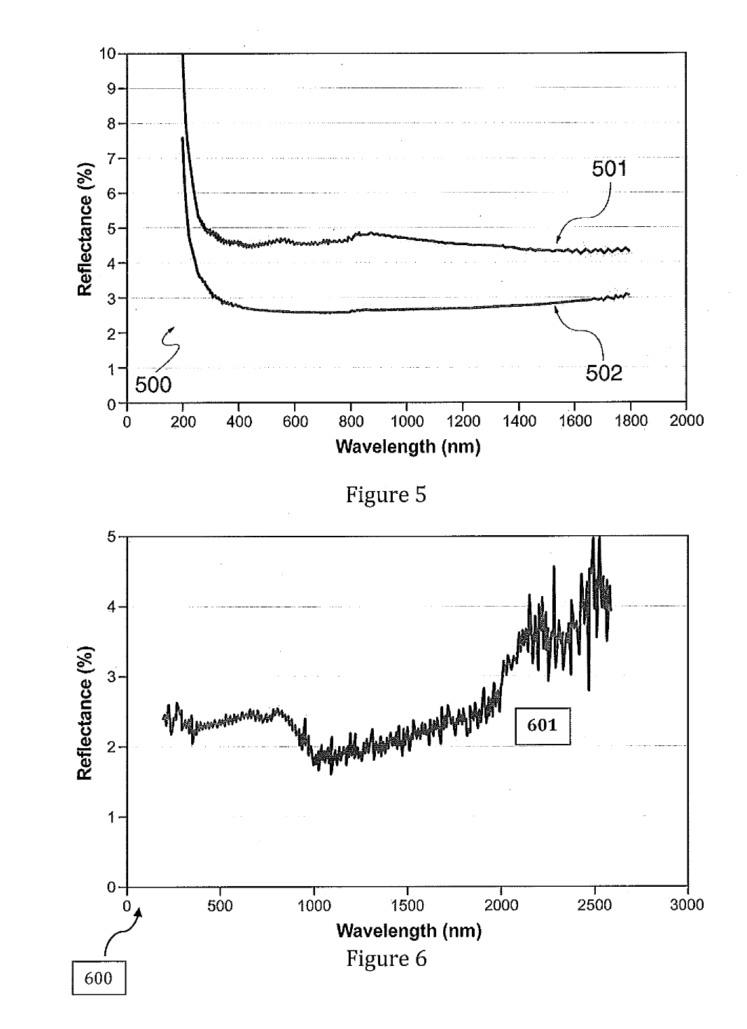

FIG. 5 shows reflectance spectra 500 of another electrode-support (Nafion® membrane) without and with an electrode. The reflectance of the Nafion® membrane 501 (without an electrode) is relatively low, between 4% and 5%. The reflectance with the electrode 502 is even lower (about 2%), but the shapes of the spectra are somewhat different from that of the GDLs shown by spectra 306 and 304 in FIG. 3. The spectrum of the film, without electrode, exhibits fringes in the long wavelength range.

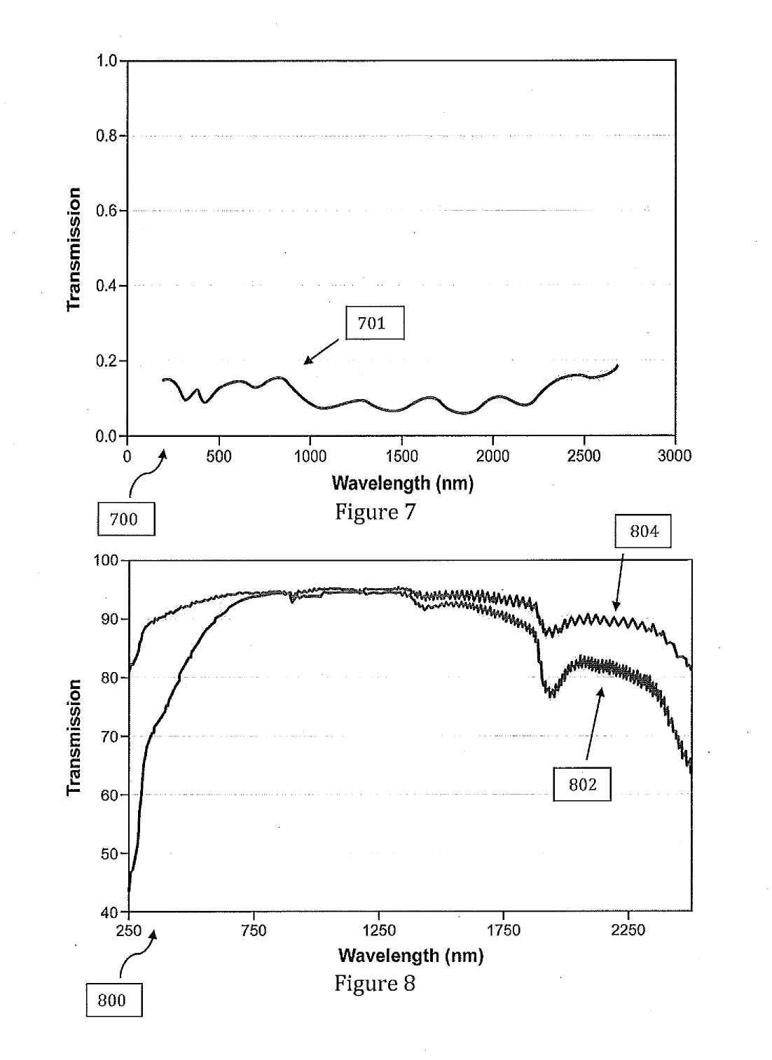

From the spectral data, it can also be seen that PEM electrodes and support materials exhibit transmission spectra that represents the porosity of the electrode. It is important to point out that gas diffusion electrode support material has a “woven” structure and a certain degree of porosity. Indicative thereof, when the gas diffusion support paper is illuminated with a laser pointer, one can see a small transmission. Measurements of the transmission spectrum of the GDL support paper are set out herein. FIG. 6 shows the reflectance spectrum 600 of another catalyst-coated Nafion® film. The reflectance 601 of the electrode material is about 2%, which is about the same as the electrode coated, carbon-based support material. FIG. 7 shows the transmission spectrum 700 of the electrode coated Nafion® membrane whose reflectance spectrum 601 is shown in FIG. 6. We also observe that the transmittance 701 is about 0.2%. Because the transmittance can be related to the porosity of the electrode, it is seen that the porosity of the electrode is very low.

It may be seen that:
(1) There is little transmission from the electrode coated densely woven GDL paper.
(2) The transmission of the densely structured GDL support paper is only about 2%.
(3) The transmission of the loosely structured GDL support paper is considerably higher, at about 35%, because it is a much more loosely woven fiber.
(4) PEM Nation® membrane has about 5% reflectance, which is further lowered to about 2% after deposition of the electrode.
   Based on these observations, it can be seen that transmission characteristics can be used to determine the porosity of the material.

The above results indicate that the local reflectance and transmission spectra of fuel cell materials carry detailed information about the thickness, composition, surface morphology, and porosity. Hence, interference fringes and absorbance in the UV-Vis range can be used for measurement of thickness and/or composition of PEM membranes. Moreover, reflectance and the transmission spectra can be used to monitor the quality of the MEA component. Finally, reflectance of electrode layer (on all supporting materials) is characteristic of the electrode material and its morphology.

The following describes techniques for applying these results for monitoring large-area parameters in a commercially compatible manner. In the spectral data provided herein, two wavelength ranges—one with high absorption and the other of very low absorption are identifiable. This disclosure describes techniques for applying these results (fringe pattern and absorption) to monitor a number of material parameters in the manufacturing of PEM membranes. Similar techniques can be adapted for control of other membranes, sheets, thin films, and coating of a variety of other materials.

FIG. 8 shows specular transmission-spectra 800 of two Nafion® films of “nominal” thickness 2 and 4 mils (802 and 804, respectively). Several characteristics of these films are observed, which include:
(1) A broad absorption band in the UV-Visible range of wavelengths
(2) Additional three narrow, local absorption bands within the entire spectrum
(3) Interference fringes in low absorption regions, particularly in the wavelength range of 1300 nm and 1750 nm.

For λ greater than 750 nm, each of the films exhibit a fringe pattern that arises from multi-reflections within the membrane. The fringe pattern depends on the film thickness and the refractive index of the film. In particular, the fringe spacing is inversely proportional to the film thickness, while the fringe contrast depends on the refractive index (composition) of the membrane material. One can also see the fringe pattern is modulated by some absorption peaks of Nafion®.

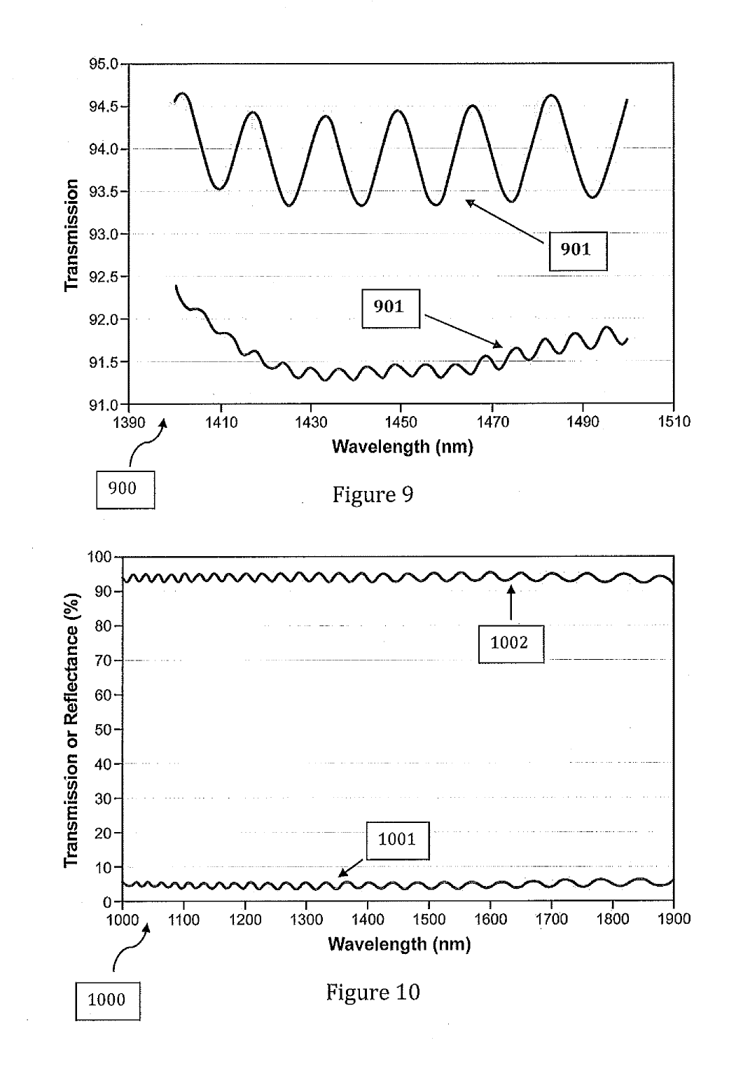

FIG. 9 shows an enlarged view of the fringe pattern 900 of the two films in the wavelength range of 1390 nm and 1500 nm. From FIG. 9, it is seen that the pitch of the fringes for the thinner membrane 901 is lower than that of the thicker membrane 902. The thickness of the membranes can be determined from the considerations. The minima of the fringe pattern occur when:

n·t=(m+1)(λ/4),m=0,2,4, . . . ; and

and the maxima occur when:

n·t=(m+1)(λ/4),m=1,3,5, . . .

It is also seen that the ratio of the pitch is 8/3 indicating a thickness ratio (thicker film/thinner film) is 2.66 rather than the nominal ratio of 2. To confirm the thickness ratio, the actual thickness of each of the membranes was measured and found that the actual average thicknesses of the 2-mil and 4-mil membranes are 1.8 mil and 4.8 mils respectively, giving a thickness ratio of 2.66.

It is important to note that the contrast of fringes is low. It may also be noted that the contrast is even lower for the thicker films. The low contrast of the films is simply due to low refractive index of the polymer (typically about 1.5). Hence, the low fringe contrast of polymer films suggests use of a measurement system with a high signal-to-noise ratio. The lower fringe contrast of the thicker film may be due to two factors: (i) the wavelength region that exhibits the fringe pattern in FIG. 8 is in the proximity of an absorption band of the polymer, and (ii) thicker film has scattering within bulk of the film.

Reflectance may also be used to monitor the fringe pattern. FIG. 10 shows the reflectance and transmission fringes (1001, and 1002, respectively) of a 1-mil Nafion® membrane. Note that the transmission fringe pattern 1002 rides on a very large dc signal compared to the reflectance fringe pattern 1001 where the dc signal is quite small.

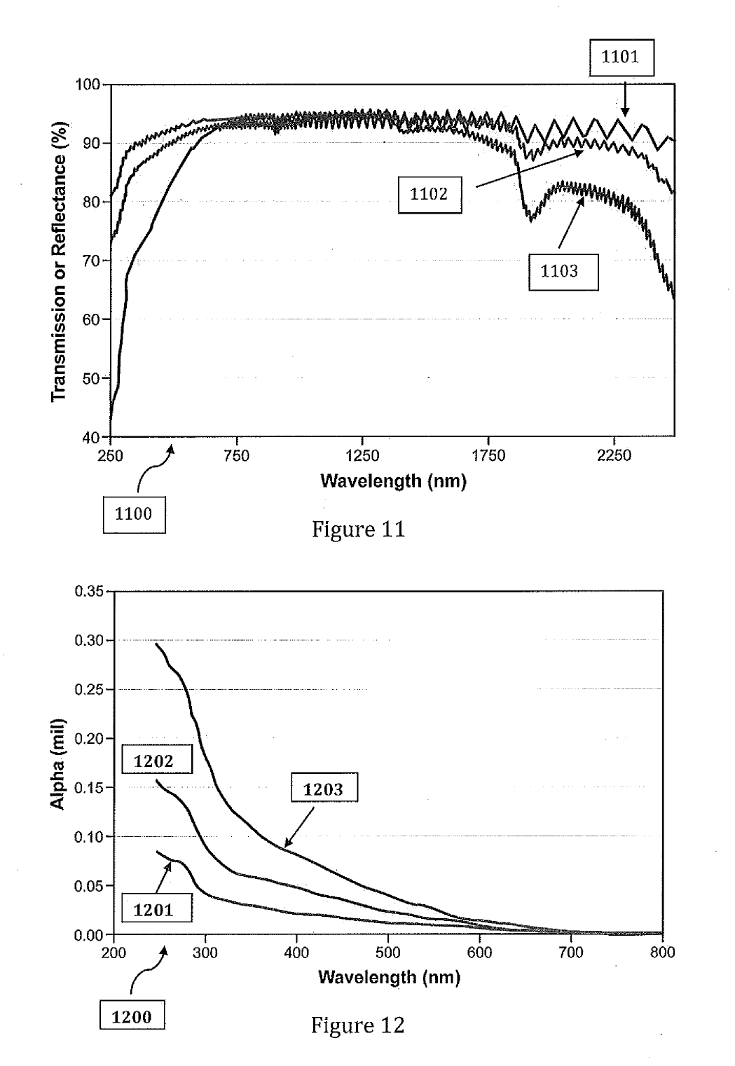

Referring now to FIG. 11 which shows transmission spectra 1100 of three different Nafion® membranes in the wavelength (λ) range between 250 nm and 700 nm. The membranes showing spectra 1101, 1102, and 1103 have thicknesses of 1 mil, 2 mils, and 3 mils respectively. Each of the membranes shows absorption that decreases with an increase in the wavelength. As expected, the thicker film has a higher pitch of interference fringes in the longer wavelength range. Likewise, in the long wavelength range, the transmission values of curve 1102 are between those of 1101 and 1103. However, in the shorter wavelength range, the transmission of curve 1102 is not between 1101 and 1103. This is because the composition of the membrane of curve 1102 is not the same as that of membranes of curves 1101 and 1103, because the absorption of the Nafion® membranes can also depend on the composition of the polymer.

For an absorbing film, the transmission T can be expressed as:

T(λ)=T₀(λ)e^{-αt}

where T(λ) is the transmission at a given wavelength λ, T₀(λ) is the transmission without the film, α is the absorption coefficient of the film material.

From the curves 1100 of FIG. 11, we see that absorption of the material is higher at shorter wavelengths. Thus, we see that in the case of the above films, the film thickness can also be determined from the fringe pattern (longer wavelength range) as well as from the absorption (in the shorter wavelength range). This is assuming the refractive index and the absorption coefficient of the material are known. In general, both the refractive index and the absorption of a polymer film depend on the composition. However, in practice, the real part of the refractive index is a weak function of the composition, whereas absorption coefficient is a stronger function of the composition.

Further, measurement of thickness either by fringe pattern or by absorbance alone is more accurate when the composition of films is the same. However, in a general case, when both composition and thickness can vary, one may use both methods. For example, one may use the interference method for measuring thickness and the absorption method for monitoring the membrane composition.

To see the effect of changes in the composition on the spectrum of the film, FIG. 11 shows the transmission spectra of three different films—1 mil (nominal thickness) 1102, 2 mil 1104, and 4 mil Nafion® membranes 1106, each of which may have slightly different composition. It can be seen, as expected, that the pitch of the fringes is lower for thinner membranes. However, the short wavelength transmission of the 1 mil film 1102 is lower than the 2 mil film 1104, indicating a higher absorption of the 1-mil film 1102 material. Absorbance is a good indication of the membrane composition. FIG. 12 shows absorption coefficients of three Nafion® membranes (nominal thickness of 1 mil 1202, 2 mils 1204, and 4 mils 1206) as a function of the wavelength. It is seen that the spectral dependence of the absorption coefficient is quite different for these compositions.

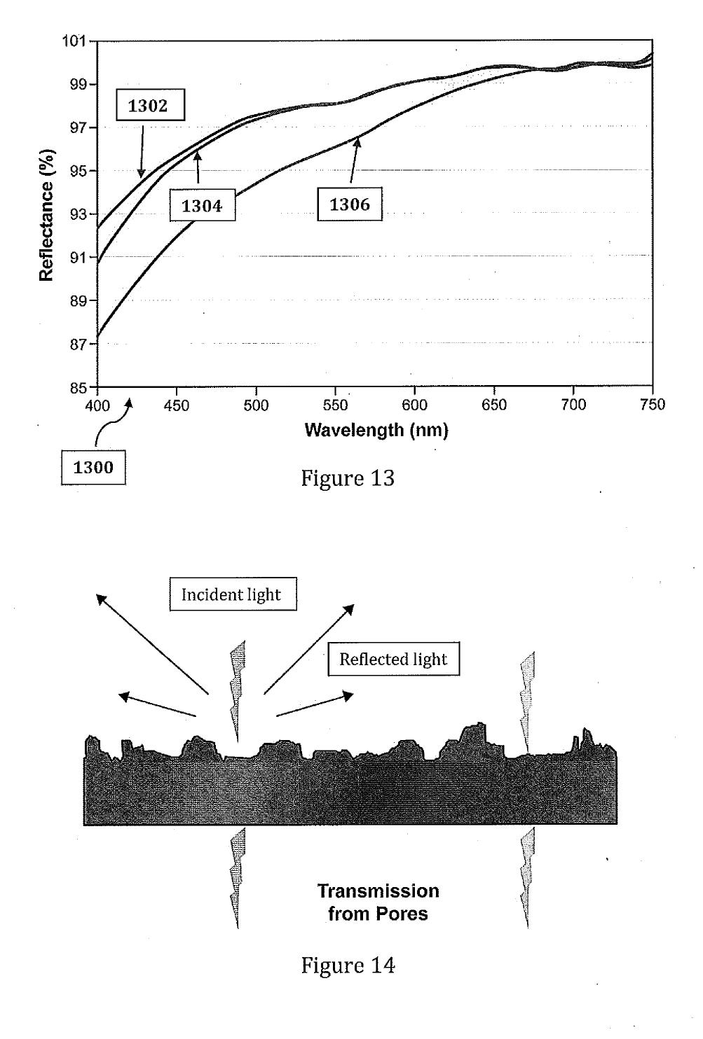

Although absorbance of a film is typically measured from a transmission spectrum, absorption effect can also be seen in the reflectance spectrum of the polymer film. In particular, the absorption effect can be enhanced by using a reflecting material at the back of the polymer film. FIG. 13 shows the reflectance spectra 1300 measured by this method. It shows three spectra. Layer 1302 is a sample of a Nafion® film with an Al reflector behind it. Layer 1304 is another sample from the same film with Al back reflector. The results of spectrum 1306 correspond to the two films put together. These results demonstrate use of a back reflector to enhance the absorption. Thus, the reflectance spectrum offers an advantage if the film can be placed on a reflecting back material as shown in FIG. 13.

In the above discussion, it is shown that transmission spectrum of a PEM films can be used to measure the thickness either by the fringe pattern or short wavelength absorption. In order to use absorption for measurement of thickness, the composition of the films should be the same, otherwise composition differences will impact thickness determination. These results also indicate that absorption may be used to monitor the composition of the film. Alternately, one can use the absorption and the fringe pattern simultaneously to monitor the composition and the thickness of the film.

Additionally, the fringe pattern can be measured in transmission mode as well as reflection mode. One possible approach for measurement of fringes: Width of the fringes (2 mil membrane)=˜20 nm. The discussion thus far indicates that the fringe pattern in the longer wavelength range can be used for thickness measurement, and absorbance in the shorter wavelength can be used for thickness and/or composition measurement.

Additionally, the fringe pattern has a low contrast—the transmission fringe pattern rides on a large dc signal; reflectance fringe pattern has a zero dc signal. Furthermore, composition of the polymer can be monitored by monitoring absorbance (for a uniform thickness). Finally, both fringe pattern and absorbance can be simultaneously measured to monitor membrane thickness and composition.

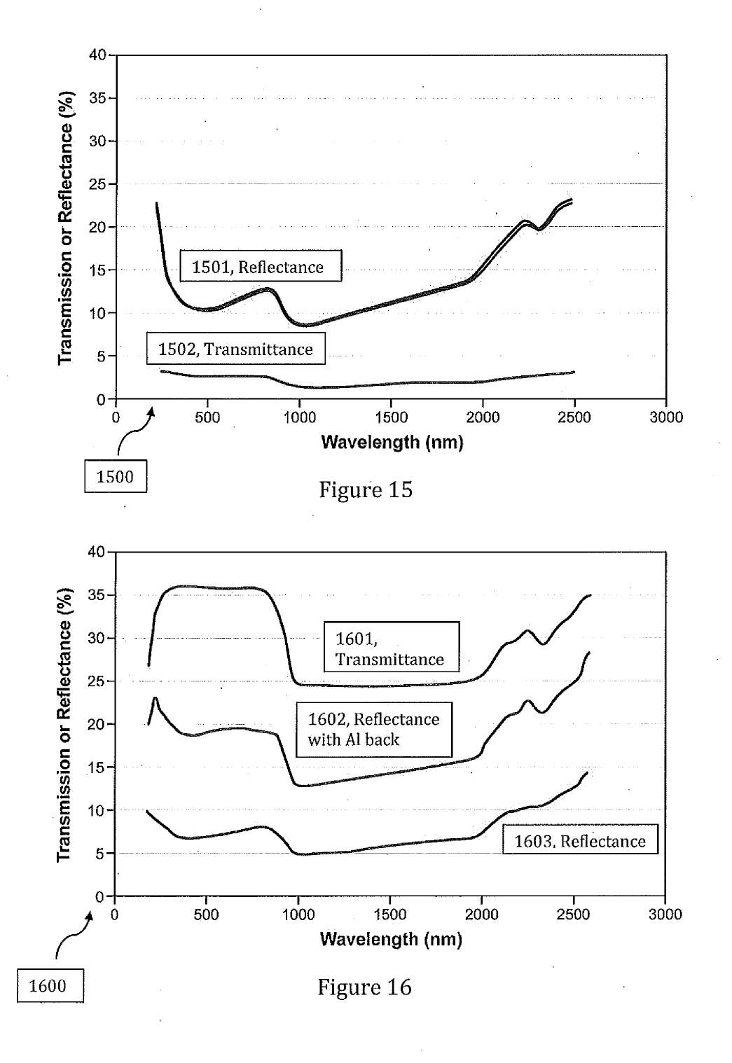

Porosity is a critical parameter for electrodes. Electrodes are fabricated on polymer membranes as well as on carbon fiber paper. The membranes have a very small pore size, which is difficult to measure with light. However, the porosity of the electrode on transparent membranes and the porosity of the C-paper can be measured from the transmission with a narrow band light source, as shown in FIGS. 14-16. FIG. 15 illustrates the reflectance and transmittance, 1501 and 1502, respectively for such an example. While, FIG. 16 illustrates the transmittance (1601), the reflectance with an Al back (1602) and the reflectance (1603).

As set forth herein, local measurements of reflectance and transmission can be used to determine a host of parameters that are critical for successful operation of a fuel cell. In commercial production, membranes, electrodes, and other materials are made in large widths and at high speeds. For process monitoring, the systems and methods discussed herein allow for continual measurement of these parameters across the width and at speed so that variations over the entire area of each material may be maintained. In most cases, GDLs, membranes, and electrodes are pulled in a web form and rolled over metallic drums.

The following provide various possible systems and apparatus for making large-area measurements of thickness, surface morphology, and porosity.

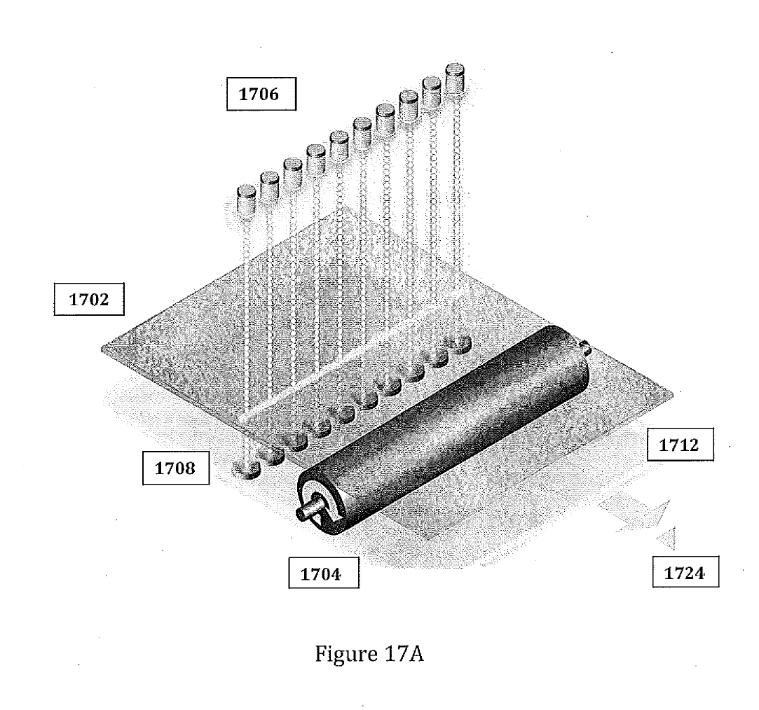

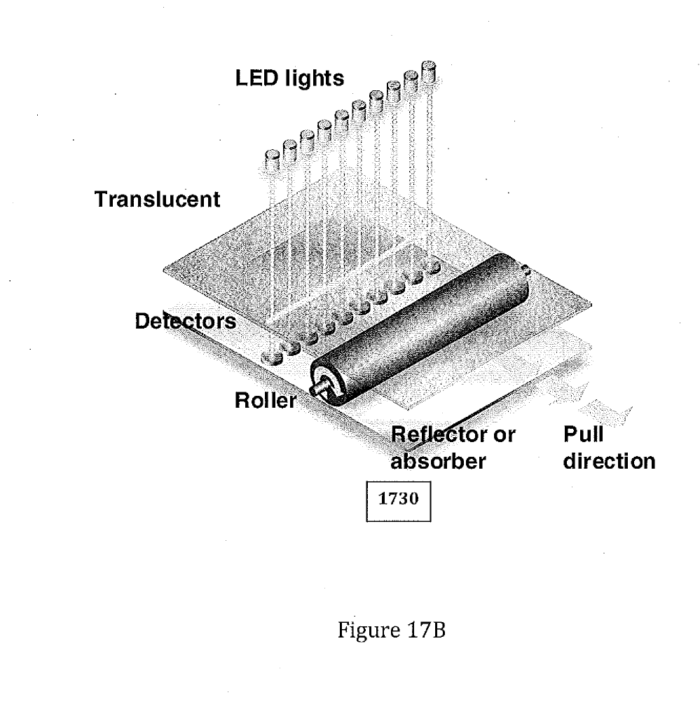

FIGS. 17A and 17B illustrate an array of LEDs 1706 (or other appropriate light sources) aligned along the width of a membrane or electrode 1702. A roller 1704 may transport the membrane through an inspection point 1712 in a pull direction 1724. Detectors 1708, positioned below the membrane 1702 and positioned to detect transmitted light, will sequentially determine the thickness as discussed herein. Electronic circuits based on multichannel boards can be used for this purpose. A variety of LEDs 1706 in a range of wavelengths from 0.4 μm to 1.57 μm are commercially available.

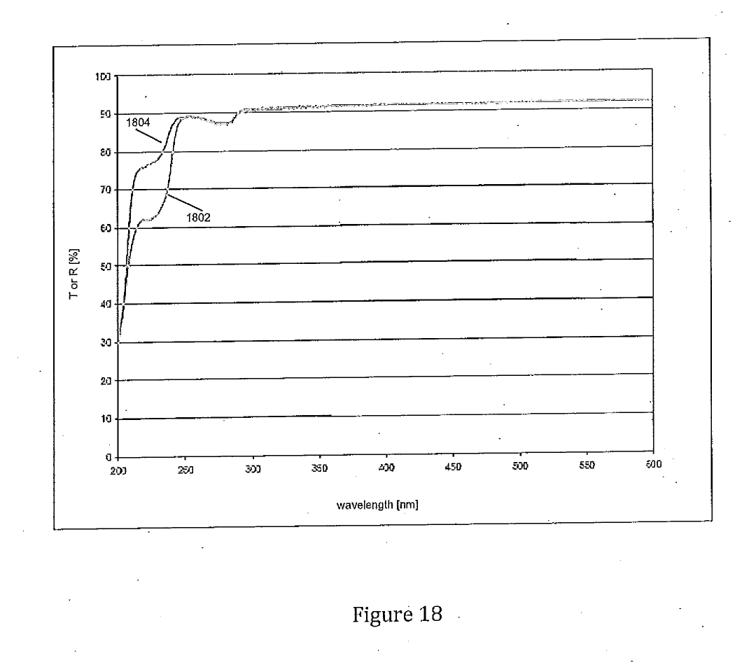

Some membrane material 1702 has low absorption in the vis-IR region. The thickness of this material can be measured by the interference fringe technique, as described earlier On the other hand, absorption technique is well suited for memebranes that have high absorption, particularly in the short wavelength range. FIG. 18 shows transmission spectra 1802 and 1804 of two Nafion® membranes that exhibit high absorption. As shown in FIG. 18, there is an absorption band below 400 μm, for which light sources with wavelengths in the 0.2 μm to 0.3 μm ranges, may be employed. In FIG. 17B, one can control the light signal by having appropriate shields such as a reflector or an absorber 1730.

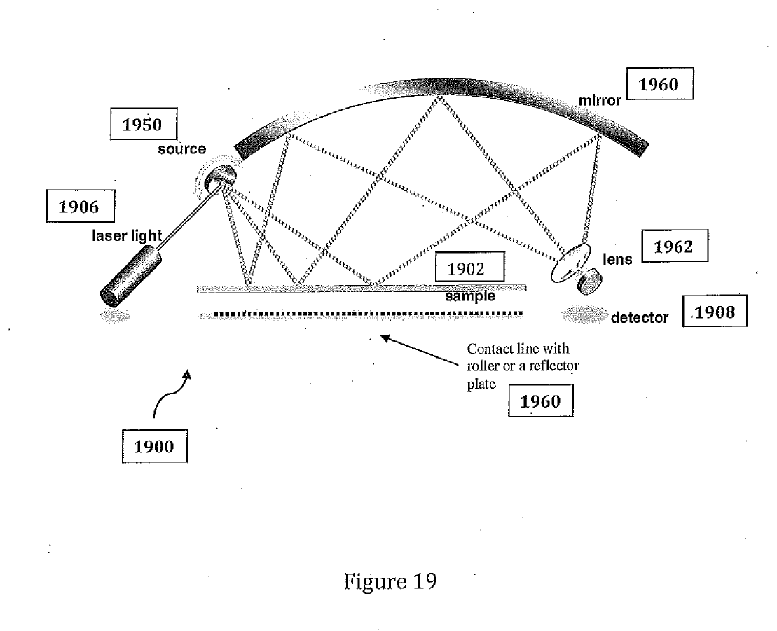

FIG. 19 is a sketch 1900 of a system that may be used for monitoring surface morphology as well as membrane thickness based on absorption. To measure the membrane thickness by absorbance technique, a reflector 1960 is placed behind the membrane (sample) 1902. The light, provided by one or more light sources such as a laser 1906, that passes though the membrane 1902 (hence includes absorption) is also reflected into the detector 1908. For example, one can take advantage of the roller, which is often a part of the web pulling system, to reflect the light that is transmitted by the membrane 1902. In this system, the light source 1906 is scanned by a moving mirror 1950 to produce a line illumination over the membrane 1902. The reflected signal, as a function of time, impinges on different parts of a reflector 1960. The reflector (mirror) 1960 is shaped to direct the signal to a fixed detector 1908. A lens 1962 in front of the detector alleviates tolerances for the reflector 1960. A similar system can be used to monitor the transmission provided the reflector 1960 is can be located behind the membrane.

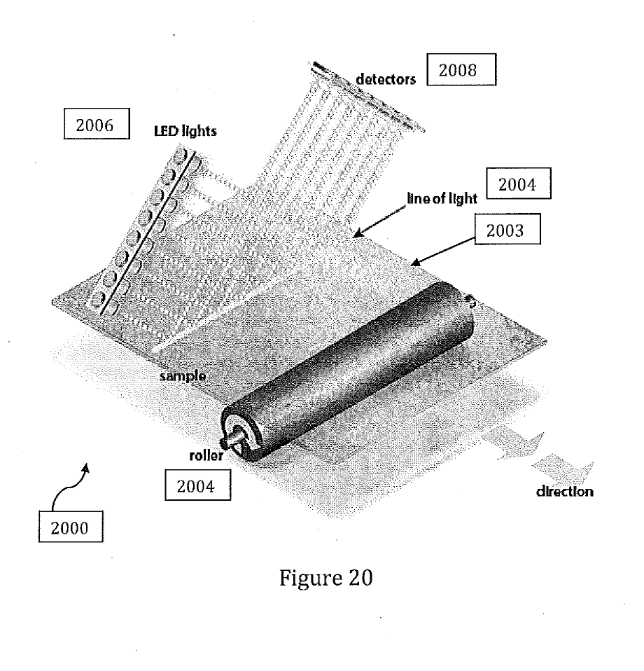

FIG. 20 shows another approach, which uses several LEDs 2006 and corresponding detectors 2008 to make reflectance measurements along the width of a web membrane 2002 that is transported by a roller 2004 through an inspection point 2012. In the system 2000 of FIG. 20, the LED's 2006 (or other appropriate wavelength light sources) and detectors 2008 are arranged angularly relative to the surface 2003 of the membrane 2002. In one possible arrangement, the line of light sources 2006 is arranged orthogonally relative to the line of detectors 2008, with their plane intersecting the membrane surface 2003 in a line 2004.

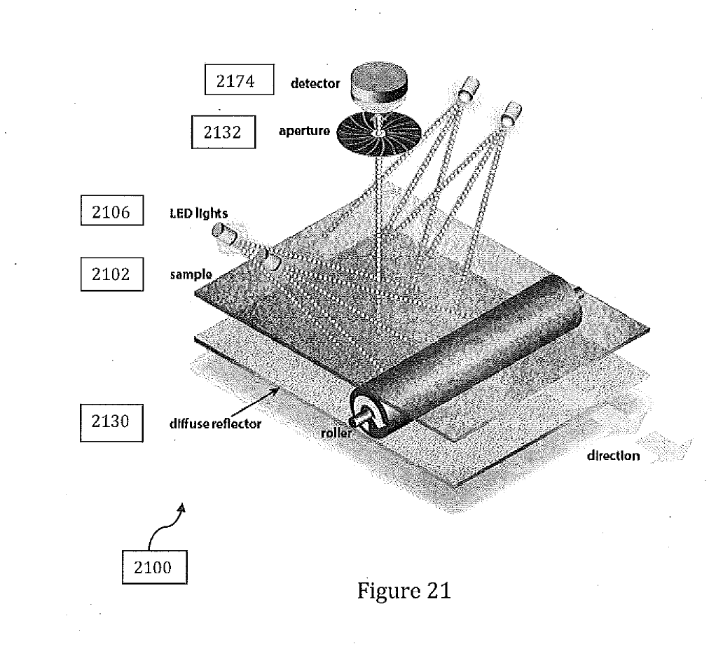

An alternate system 2100 to measure absorbance or reflectance of large-area membrane or a sheet is illustrated in FIG. 21. Here a section of the membrane 2102 is illuminated with light sources 2106 (e.g. LEDs) with very large divergence, and the reflectance normal to the membrane 2102 is measured by a detector 2174 positioned above the membrane 2102. The reflected light can pass through an aperture 2172 before reaching the detector 2174. The system 2100 may include a reflector or an absorber 2130. This system 2100 can be used for thickness measurement by reflectance (fringe pattern), absorbance, as well as for measurement of electrode morphology.

This disclosure shows that measurements can be made very rapidly and in the production environment for thickness of the membranes; compositional changes of the membrane material; porosity and surface morphology of the electrode; and defects in the membranes.

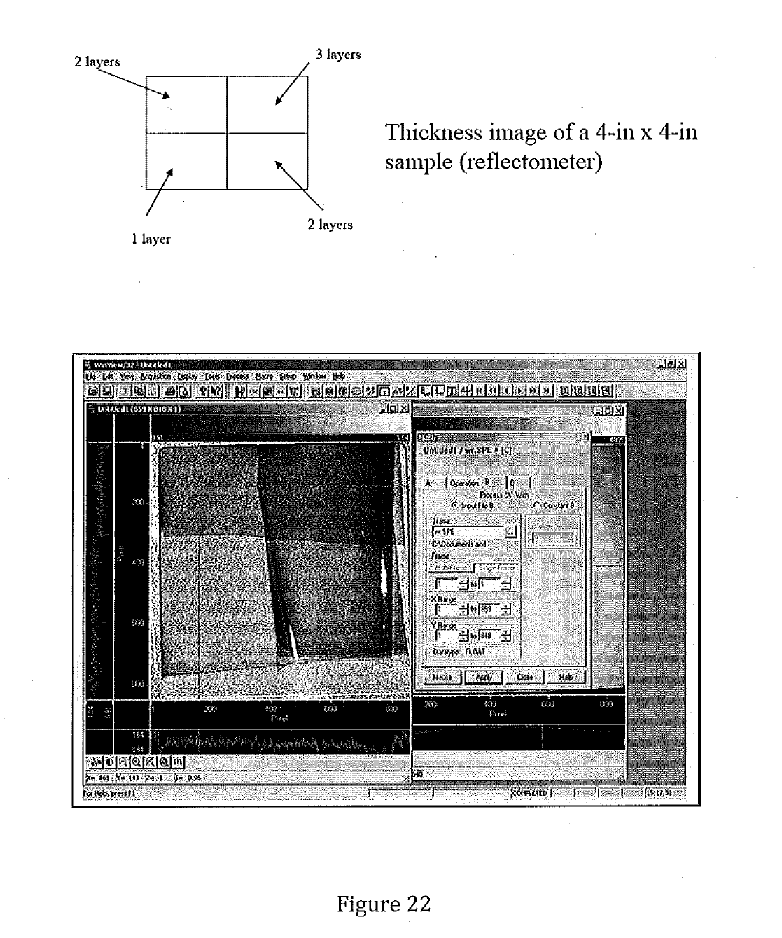

FIG. 22 illustrates by example results of using absorbance to produce thickness image of a Nation® membrane. Here a membrane was cut into pieces and these pieces were overlayed to form a 4-in×4-in composite membrane 2201 in which layers are dispersed in a way so as to form parts of the composite consist of one, two, and three layers. The imaging was done by a system similar to that shown in FIG. 21.

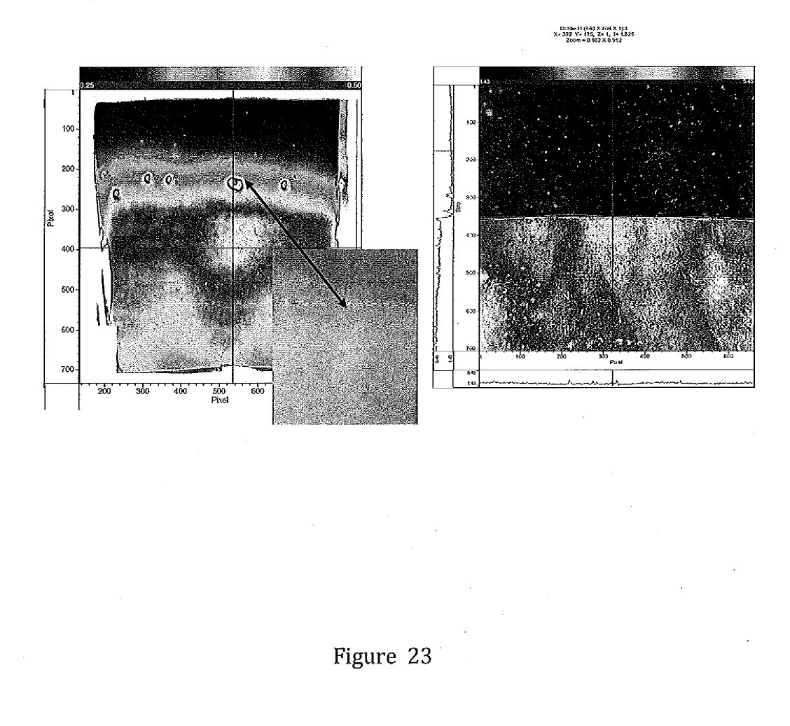

FIG. 23 illustrates an image of two different defects inside PEM membranes: (a) sample with a line of bubbles, and (b) sample with an invisible impression defect resulting in a 10% thickness reduction.

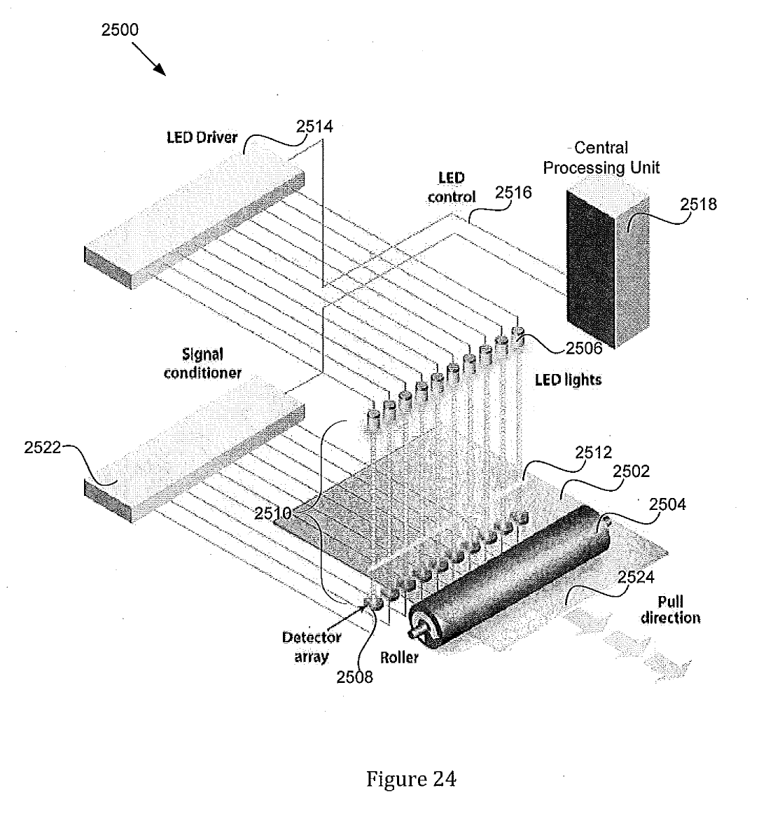

FIG. 24 illustrates an example of an automated system for continuously measuring materials using transmission principles, as taught herein. The automated system may include a computer configured to control and LED driver, a signal conditioner, and a detector array, in order to control the timing of the LED and detector array to a roller or belt on which a membrane may travel during manufacturing.

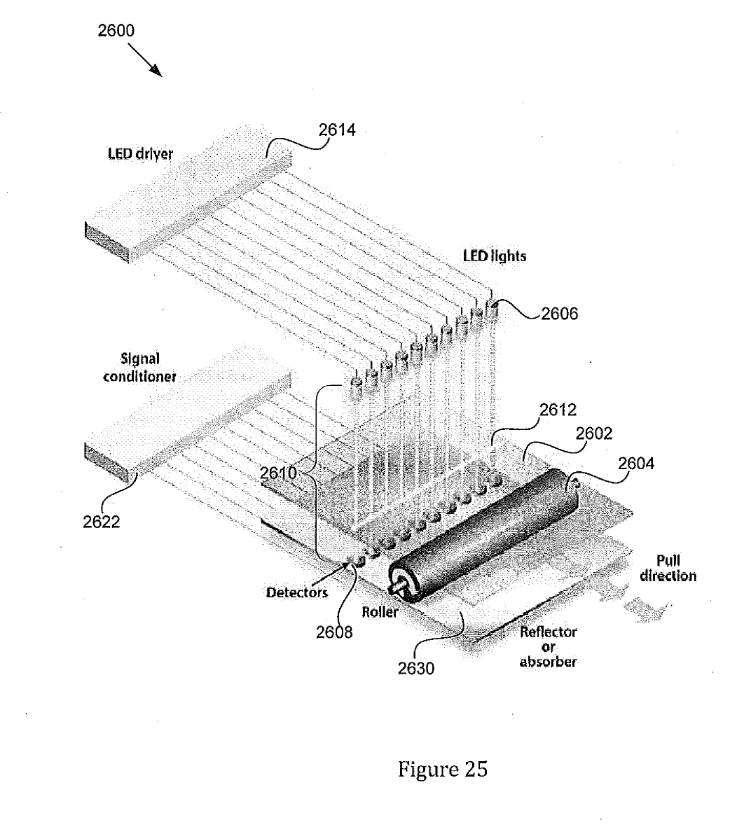

FIG. 25 illustrates certain embodiments, similar to those shown in FIGS. 17A, 17B, and 24, in which an automated system 2500 continuously inspects one or more membranes 2502, for example, as part of a commercial processing assembly. The membranes 2502 can be proton exchange membranes. Each membrane 2502 is moved along a line by a metallic drum or roller 2504 that can operate at high speeds. The roller 2504 may form part of a membrane conveyer that moves each membrane 2502 during an inspection process. The automated system 2500 uses a plurality of LEDs 2506 and detectors 2508 placed as a plurality of LED-detector pairs 2510 to inspect each membrane 2502. The LED-detector pairs 2510 form an inspection point or examination position 2512. Other light sources such as lasers may be used instead of, or in addition to, the LEDs 2506. The number of LED-detector pairs 2510 may vary in order to measure the entire width of the membrane being inspected. In other embodiments, the LED-detector pairs 2510 are placed to measure specific locations on each membrane 2502. The LED-detector pairs 2510 can be placed in a straight line or along a curve. In some embodiments, each LED 2506 is placed above the membrane 2502 and each corresponding detector 2508 is placed below the membrane 2502 in order to measure absorption of light transmitted onto the membrane 2502.

In some embodiments, each LED 2506 is coupled to an LED driver 2514, which is part of an LED control 2516, to a central processing unit 2518. The central processing unit 2518 transmits LED control signals to the LED driver 2514. In some embodiments, a single LED driver 2514 triggers or activates each of the LEDs 2506, while in other embodiments multiple LED drivers 2514 are used. The central processing unit 2518 can be part of a computer or the central processing unit 2518 can be incorporated into a stand-alone device. The LED driver 2514 can be tied to a single I/O board that is coupled to the central processing unit 2518. In some embodiments, the detectors 2508 are coupled to a multichannel signal conditioner 2522 that is coupled to the central processing unit 2518. To continuously monitor or inspect the membrane 2502, the central processing unit 2518 signals the LED driver 2514, which causes the LEDs 2506 to transmit light onto the membrane 2502. In some embodiments, the central processing unit 2518 causes each LED 2506 to transmit light simultaneously, sequentially, or in another particular pattern. For measurement of, for example, thickness by absorption, composition, and/or porosity, the LEDs 2506 can operate continuously. Alternatively, the LED driver 2514 may trigger or activate the LEDs 2506 at a particular frequency.

In some embodiments, the detectors 2508 transmit a detector signal, which is based on light received by the detector, to a multichannel signal conditioner 2522 that conveys information to the central processing unit 2518. The central processing unit 2518 utilizes detector signals to compute the corresponding parameter (e.g., thickness, composition, and/or porosity). In some embodiments, the central processing unit 2518 also uses data corresponding to the LED control signals to determine parameters. The central processing unit 2518 may also correlate the determined parameters to the X-Y position of the membrane 2502 that was measured. In some embodiments, the central processing unit 2518 uses the determined parameters to adjust the membrane manufacturing process. For example, the central processing unit 2518 may create specific instructions that, when implemented, alter the assembly process in order to change the characteristics or properties of the inspected membrane and/or later-manufactured membranes.

In some embodiments, each LED 2506 and its corresponding detector 2508 are simultaneously triggered. For example, the LEDs 2506 can be triggered or activated by the LED driver 2514 and the detectors 2408 can be triggered or activated through the multichannel signal conditioner 2522. The triggered LED-detector pairs 2510 may be used to measure a fringe pattern. In some embodiments, the LED-detector pairs 2510 are triggered at a specific rate based on, for example, how fast the membrane 2502 is moving. In other embodiments, the LED-detector pairs 2510 operate continuously, for example, when measuring the thickness of a membrane 2502.

In some embodiments, the roller 2504 continuously transports each membrane 2502 during an inspection process. As the front end 2524 of the first membrane 2502 approaches the LED-detector pairs 2510 (e.g., the inspection point 2512), the central processing unit 2518 sends the LED control signals to the LED driver 2514 and the inspection process begins. The central processing unit 2518 can save the parameters and their corresponding X-Y positions in a data set associated with the first membrane 2502. A second membrane may be inspected immediately after the inspection of the first membrane is completed. The central processing unit may then create a second data set that is associated with the second membrane. This process can be repeated for any number of membranes (e.g. 10, 100 or more). In other embodiments, the automated system runs continuously to inspect, for example, a large membrane sheet that is later divided into smaller membranes.

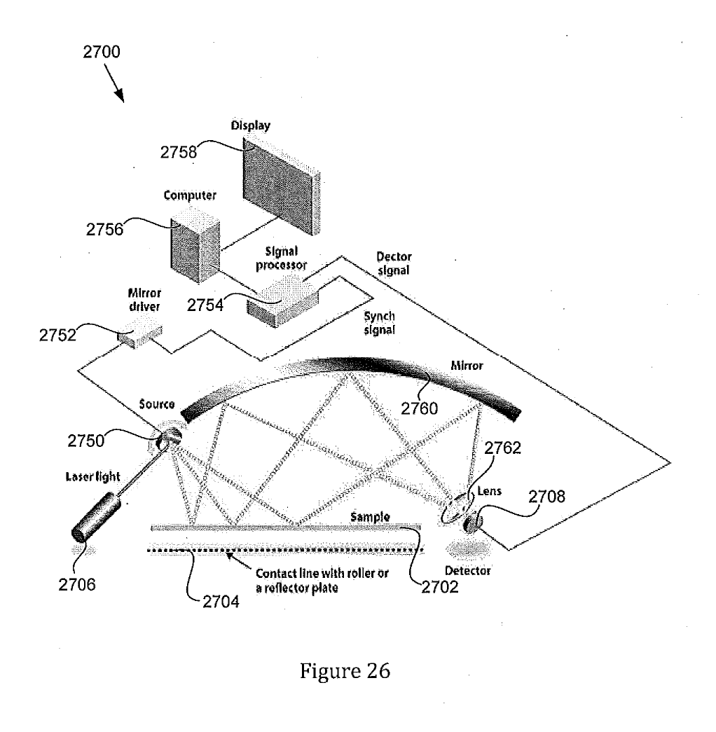

The embodiments shown in FIG. 26 are similar to those shown in FIG. 17B. As shown in FIG. 26, the automated system may incorporate a backplane 2630 for ambient control. The backplane 2630 can be formed of reflecting material or an absorbing material. For example, the reflecting material may include a coating such as silver or aluminum, while the absorbing material may incorporate black ink.

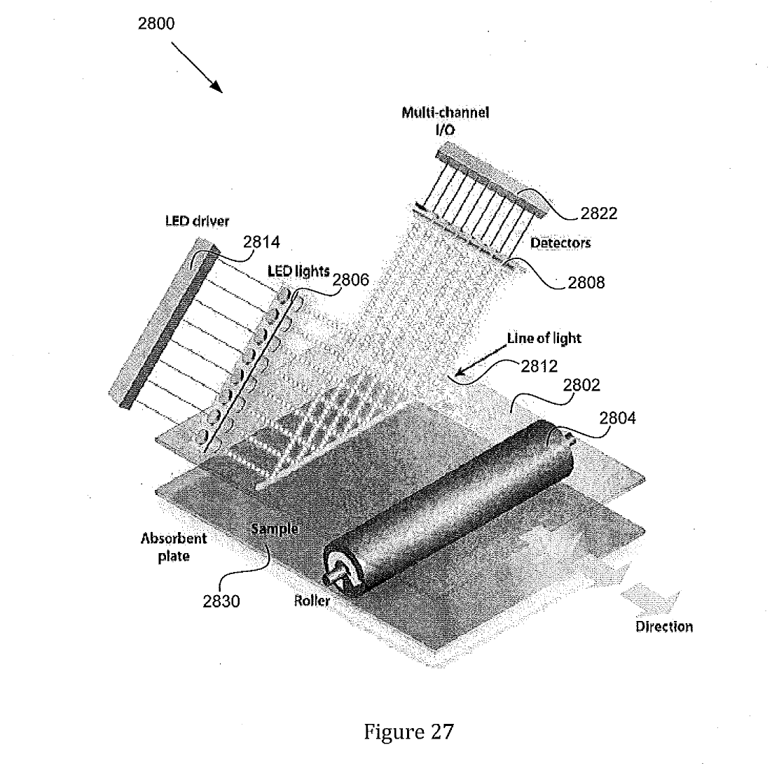

FIG. 27 illustrates an automated system 2700 for inspecting membranes using a scanning mirror 2750, which directs light in order to continuously inspect the membrane 2702 or efficiently measure multiple membranes. The embodiments of FIG. 27 are similar to the embodiments illustrated in FIG. 19. Some embodiments of FIG. 27 use a light source 2706, such as a laser, that directs light onto a scanning mirror 2750, or source. That scanning mirror 2750 is coupled to a mirror driver 2752, which receives sync signals from a signal processor 2754 that instructs the mirror driver 2752 to move the scanning mirror 2750. The signal processor 2754 may receive input from a computer 2756 or central processing unit within the computer 2756.

In some embodiments, the automated system 2700 adjusts the scanning mirror 2750 to produce a line illumination over the membrane 2702. Light is reflected off the membrane 2702 and impinges on different parts of a reflector or mirror 2760. The reflector or mirror 2760 is shaped to direct the reflected light to a fixed detector 2708. In some embodiments, the roller 2704 may be used to reflect light that is transmitted through the membrane 2702. A lens 2762 may be placed in front of the detector 2708 to alleviate tolerances for the reflector 2760. The detector 2708 converts received light into electronic signals that are transmitted to the signal processor 2754. In some embodiments, the same signal processor 2754 is configured to receive signals from the detector 2708 and to transmit instructions to the mirror driver 2752. The signal processor 2754 is coupled to a central processing unit, e.g., a computer 2756, which analyzes the information sent from the detector 2708 to determine various characteristics of the membrane. The measured characteristics may be stored as a data set associated with the scanned membrane and/or may be output to a display 2758. In some embodiments, the movement of the scanning mirror 2750 or source is used to identify the location on the membrane 2702 where the parameters are measured.

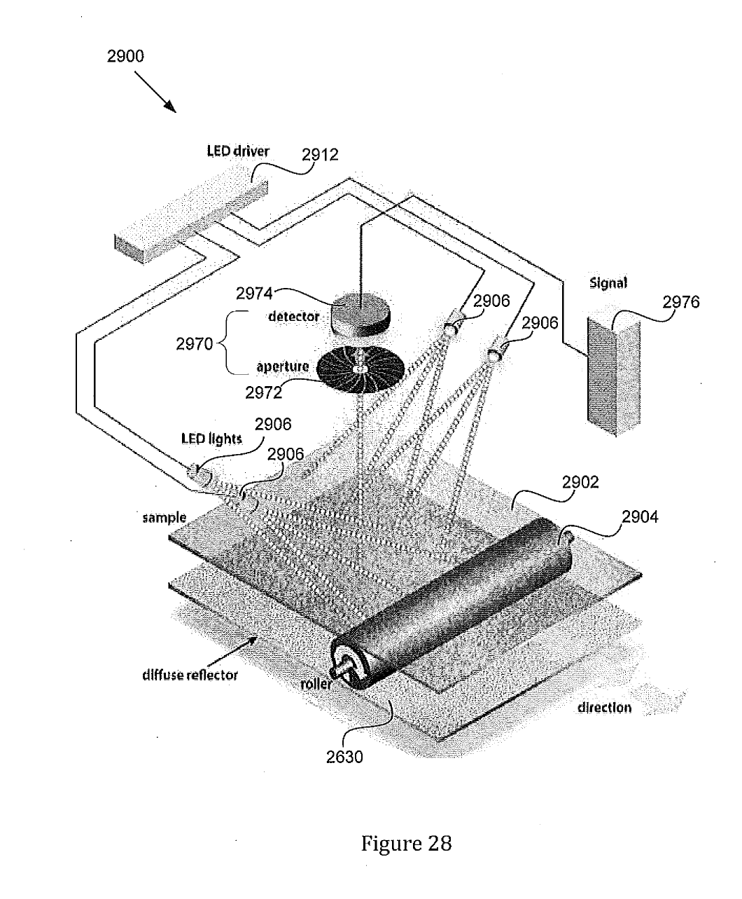

FIG. 28 illustrates a system 2800 in which the LEDs 2806 are placed at an angle with respect to the membrane 2802. The embodiments illustrated in FIG. 28 are similar to the embodiments illustrated in FIG. 20. As shown in FIG. 28, each LED 2806 is coupled to an LED driver 2814. The detectors 2808 are positioned to receive light emitted from the LEDs 2806 and reflected off the membrane 2802. The detectors 2808 are coupled to a multichannel signal coordinator or multi-channel I/O board 2822, which may be coupled to a computer for data analysis. In some embodiments, the LEDs 2806 are positioned at approximately 45 degrees with respect to the membrane 2802. In other embodiments, the LEDs 2806 form an angle from approximately 45 degrees to slightly less than 90 degrees with respect to the membrane 2802; in yet other embodiments, the LEDs 2806 form an angle from approximately 45 degrees to slightly more than 0 degrees with respect to the membrane 2802. Thus, the LEDs 2806 may be placed at a substantially non-perpendicular angle with respect to the membrane 2802. The detectors 2808 are positioned at a corresponding angle in order to receive the light transmitted from the LEDs 2806 and reflected off the membrane 2808. In some embodiments, an absorbent plate 2830 is placed below the inspected membrane 2802. In other embodiments, additional detectors 2808 and/or LEDs 2806 are placed below the membrane 2802 in order to measure both reflectance and transmission of the light with respect to the membrane 2802.

FIG. 29 illustrates a system 2900 that uses a reflectometer 2970 to continuously inspect membranes. Embodiments illustrated in FIG. 29 are similar to the embodiments illustrated in FIG. 21. As shown in FIG. 29, one or more LEDs 2906 may be placed at various angles with respect to the membrane 2902. In some embodiments, each LED 2906 is placed at the same angle with respect to the membrane 2902. In other embodiments, each LED 2906 may be placed at different angles with respect to the membrane 2902. The LEDs 2906 can be coupled to one or more LED drivers 2912 that cause each LED 2906 to transmit light. The reflectometer 2970 includes an aperture 2972 and a detector 2974. The aperture 2972 and detector 2974 are placed above the membrane 2902 to receive light reflected at an angle perpendicular to the membrane 2902. The detector 2974 is coupled to a signal processor 2976, which may include a central processing unit that analyzes signals generated by the detector 2974. In some embodiments, the automated system 2900 may measure the reflectance of the entire illuminated region as a single value. Hence, the average reflectance of the entire width can be monitored as the membrane 2902 moves through the automated system 2900. In other embodiments, the detector 2974 may be replaced with a camera to image each section of the membrane 2902. The central processing unit in the signal processor 2976 can use the signals sent by the detector 2974, alone or in combination with other data or signals, to determine characteristics of the membrane 2902. For example, the automated system 2900 may use absorbance imaging to determine the thickness of the membrane 2902, to identify any defects (e.g., surface or bulk defects) in the membrane 2902, and/or determine the surface morphology of the membrane 2902.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

1. An automated system for analyzing a plurality of proton exchange membranes comprising:
a membrane conveyer configured to transport a first proton exchange membrane of the plurality of proton exchange membranes through an examination position;
at least one light source configured to transmit light onto the first proton exchange membrane when the first proton exchange membrane is in the examination position;
at least one light detector configured to detect light from the first proton exchange membrane and transmit a detector signal representative thereof;
at least one light source driver coupled to the at least one light source, wherein the at least one light source driver is configured to activate the at least one light source; and
a central processing unit configured to receive the detector signal from the at least one light detector and to determine one or more characteristics of the first proton exchange membrane based on the detector signal.

2. The automated system of claim 1, wherein the at least one light source, the at least one light detector, and the central processing unit are configured to measure absorption of the light transmitted onto the first proton exchange membrane.

3. The automated system of claim 1, wherein the at least one light source, the at least one light detector, and the central processing unit are configured to measure reflectance of the light transmitted onto the first proton exchange membrane.

4. The automated system of claim 1, wherein the at least one light source is positioned above the first proton exchange membrane when the first proton exchange membrane is in the examination position, wherein the at least one light detector is positioned above the first proton exchange membrane when the first proton exchange membrane is in the examination position, wherein the one or more characteristics of the first proton exchange membrane includes thickness of the first proton exchange membrane, and wherein the central processing unit is configured to determine the thickness of the first proton exchange membrane using absorbance imaging.

5. The automated system of claim 1, wherein the at least one light source is positioned above the first proton exchange membrane when the first proton exchange membrane is in the examination position, wherein the at least one light detector is positioned above the first proton exchange membrane when the first proton exchange membrane is in the examination position, wherein the one or more characteristics of the first proton exchange membrane includes identification of surface or bulk defects in the first proton exchange membrane, and wherein the central processing unit is configured to determine the identification of surface or bulk defects of the first proton exchange membrane using absorbance imaging.

6. The automated system of claim 3, further comprising:
a scanning mirror;
a mirror driver coupled to the scanning mirror, wherein the mirror driver is configured to move the scanning mirror to reflect light from the at least one light source onto the first proton exchange membrane when the first proton exchange membrane is in the examination position; and
a reflector configured to direct light reflected from the first proton exchange membrane towards the at least one light detector.

7. The automated system of claim 6, further comprising a lens placed between the reflector and the at least one light detector.

8. The automated system of claim 1, wherein the central processing unit is further configured to adjust an automated manufacturing process for a second proton exchange membrane using the one or more determined characteristics.

9. The automated system of claim 1, wherein the at least one light source comprises a first light source and a second light source, and wherein the at least one light detector comprises a first light detector configured to detect light transmitted by the first light source and a second light detector configured to detect light transmitted by the second light source.

10. The automated system of claim 9, wherein the at least one light source driver is configured to activate the first light source and the second light source simultaneously.

11. The automated system of claim 9, wherein the at least one light source driver is configured to activate the first light source and the second light source sequentially.

12. The automated system of claim 3, wherein the at least one light source is placed at a substantially non-perpendicular angle with respect to the first proton exchange membrane.

13. The automated system of claim 12, wherein the at least one light detector is placed at a substantially non-perpendicular angle with respect to the first proton exchange membrane.

14. The automated system of claim 12, further comprising an aperture placed between the first proton exchange membrane and the at least one light detector.

15. A method for automatically determining characteristics of a plurality of proton exchange membranes comprising:
transporting a first proton exchange membrane through an inspection point;
transmitting light onto the first proton exchange membrane;
detecting the light after the light reaches the first proton exchange membrane;
creating a detector signal based on the detection of the at least one light signal; and
determining a characteristic of the first proton exchange membrane based on the detector signal.

16. The method of claim 15, wherein transmitting the light onto the first proton exchange membrane occurs when the first proton exchange membrane is at the inspection point.

17. The method of claim 15, wherein the light has light in the UV-Visible wavelength range.

18. The method of claim 15, wherein the light has a wavelength in the range of 750 nm to 1750 nm.

19. The method of claim 15, wherein the light comprises a first light and a second light, wherein the first light has light in the UV-Visible wavelength range, and wherein the second light has a wavelength in the range of 750 nm to 1750 nm.

20. The method of claim 15, wherein determining the characteristic of the first proton exchange membrane based on the detector signal comprises determining a surface morphology of the first proton exchange membrane.

21. The method of claim 15, wherein determining the characteristic of the first proton exchange membrane based on the detector signal comprises determining the porosity of the first proton exchange membrane.

22. The method of claim 15, wherein the light is a first light and wherein the detector signal is a first detector signal, the method further comprising:
creating a first data set associated with the first proton exchange membrane that includes the determined characteristic of the first proton exchange membrane;
transporting a second proton exchange membrane through the inspection point;
transmitting a second light onto the second proton exchange membrane;
detecting the second light after the second light reaches the second proton exchange membrane;
creating a second detector signal based on the detection of the second light;
determining a characteristic of the second proton exchange membrane based on the second detector signal; and
creating a second data set associated with the second proton exchange membrane that includes the determined characteristic of the second proton exchange membrane.

23. A method for real time adjustment of a proton exchange membrane manufacturing process comprising:
receiving a light signal transmitted through and/or reflected from a proton exchange membrane being fabricated;
determining a reflectance or transmittance of the light signal;
determining at least one characteristic of the proton exchange membrane as a function of the determined reflectance or transmittance; and
adjusting the manufacturing process to alter the at least one characteristic of the proton exchange membrane.

24. The method of claim 23, wherein the proton exchange membrane being fabricated is a first proton exchange membrane, and wherein the method further comprises producing a second proton exchange membrane using the adjusted manufacturing process.
